(19) United States
(12) Patent Application Publication
(10) Pub. No.: US 2009/0244497 A1
(43) Pub. Date: Oct. 1, 2009

(54) Projection Display Apparatus and Control Method Thereof

(75) Inventors: Ryuichiro Tanaka, Hamura-shi (JP); Takahiro Nagayoshi, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/270,660

(22) Filed: Nov. 13, 2008

(30) Foreign Application Priority Data
Mar. 31, 2008 (JP) 2008-091720

(51) Int. Cl. G03B 21/20

(52) U.S. Cl. 353/85

(57) ABSTRACT

According to one embodiment, in a projection display apparatus, laser light which has been light-modulated based on a picture signal is reflected by a scanning element which can control a light reflection angle based on the picture signal, thereby scanning the same on a screen. The projection display apparatus includes a warning module which warns that laser light will be emitted from this time on when the laser light generating element is required to generate laser light, and a control module which causes the laser light generating element to generate laser light having a preset prescribed output power in a state where the warning has been made by the warning module.

### CROSS-REFERENCE TO RELATED APPLICATIONS

This application is based upon and claims the benefit of priority from Japanese Patent Application No. 2008-091720, filed Mar. 31, 2008, the entire contents of which are incorporated herein by reference.

### BACKGROUND

1. Field

One embodiment of the invention relates to a projection display apparatus which scans laser light on a screen, thereby displaying a picture, and also relates to a control method of the projection display apparatus.

2. Description of the Related Art

As is well known, a projection display apparatus such as a color projector projects an optical image, obtained by modulating light emitted from a light source by a picture signal, onto a screen, thereby displaying a picture. Mainstream of the light source in the projection display apparatus has been shifted from a lamp to laser luminous element through LED (light emitting diode).

For apparatuses which use laser lights international safety standard has been determined concerning the amount of laser light. Therefore, in a projection display apparatus which uses a laser element as the light source, it is necessary to limit the amount of laser light emitted toward a screen in accordance with the safety standard.

The projection display apparatus of this kind has such a risk that although the amount of laser light emitted toward a screen is limited in accordance with the safety standard, if a person directly sees laser light, this can lead to blindness even if output power is low. Therefore, the projection display apparatus must be handled with sufficient care.

Jpn. Pat. Appln. KOKAI Publication No. 2004-070298 discloses that it is detected whether a human body or an obstacle invades a monitored space surrounded by detection wave between a main body of an image projection apparatus and a monitored region of a screen, and if the invasion is detected, the intensity of irradiation light toward the projection region is reduced or shut off in accordance with a state or degree of the invasion.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view for explaining an outer appearance of a laser projector in a first embodiment of the present invention;

FIG. 2 is a block diagram for explaining a signal processing system of the laser projector in the first embodiment;

FIG. 3 is a block diagram for explaining a signal processing system of a laser projector in a second embodiment of the invention;

FIG. 4 is a block diagram for explaining a signal processing system of a laser projector in a third embodiment of the invention;

FIG. 5 is a block diagram for explaining a signal processing system of a laser projector in a fourth embodiment of the invention; and

FIG. 6 is a flowchart for explaining a warning processing operation of the laser projector of the first to fourth embodiments.

### DETAILED DESCRIPTION

Various embodiments according to the invention will be described hereinafter with reference to the accompanying drawings. In general, according to one embodiment of the invention, in a projection display apparatus, laser light which has been light-modulated based on a picture signal is reflected by a scanning element which can control a light reflection angle based on the picture signal, thereby scanning the same on a screen. The projection display apparatus includes a warning module which warns that laser light will be emitted from this time on when the laser light generating element is required to generate laser light, and a control module which causes the laser light generating element to generate laser light having a preset prescribed output power in a state where the warning has been made by the warning module.

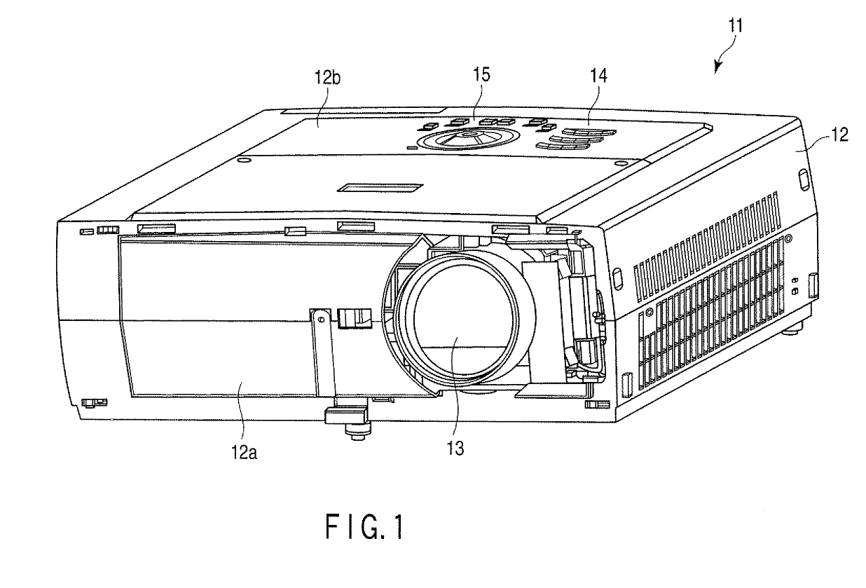

FIG. 1 shows an appearance of a laser projector 11 according to a first embodiment of the invention. That is, the laser projector 11 includes a thin and box-like stationary cabinet 12 which is a projector main body.

A laser light projecting module 13 is disposed in one end of a front panel 12a of the cabinet 12. The laser light projecting module 13 projects laser light which is modulated by a picture signal onto a later-described screen which becomes a picture projecting face disposed in front of the cabinet 12.

A display module 14 and an operating module 15 are disposed on an upper panel 12b of the cabinet 12. Of these modules, the display module 14 displays a current state of the laser projector 11, and displays a menu for setting the laser projector 11 into various modes.

The operating module 15 includes a power switch, and includes various kinds of keys for controlling the laser projector 11 into various operation states and a stop state, and for setting the laser projector 11 into various modes. These keys are exposed from the upper panel 12b so that a user can operate the keys.

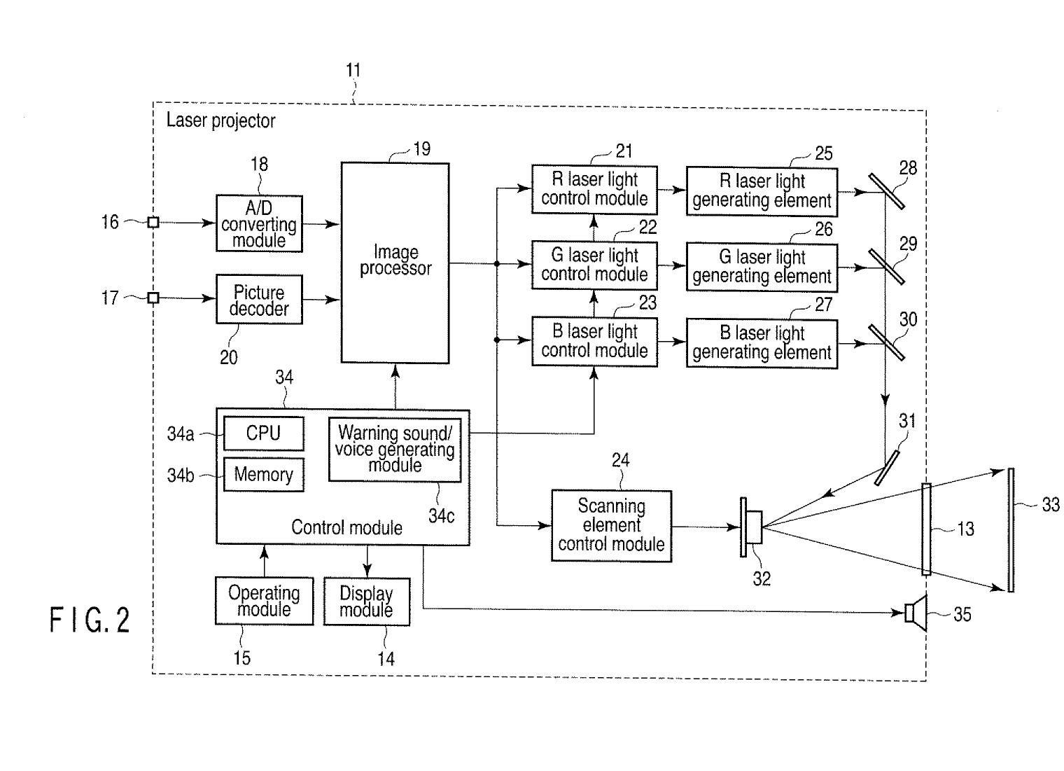

FIG. 2 shows a signal processing system of the laser projector 11. The laser projector 11 includes an input terminal 16 to which a picture signal is supplied from a PC (personal computer) (not shown) or the like, and an input terminal 17 to which a picture signal is supplied from an optical disc playback device or the like (not shown).

Of them, the picture signal supplied to the input terminal 16 is supplied to an A/D (analog/digital) converting module 18 and digitized and then, supplied to an image processor 19. Further, the picture signal supplied to the input terminal 17 is supplied to a picture decoder 20 and decoded, and supplied to the image processor 19.

The image processor 19 subjects the input picture signal to predetermined signal processing such as scaling processing that is required when a picture is projected onto a screen. Picture signals which have been signal-processed by the image processor 19 are supplied to laser light control modules 21, 22 and 23 of R, G and B, and are supplied to a scanning element control module 24.

Of them, the laser light control modules 21, 22 and 23 of R, G and B control laser light generating elements 25, 26 and 27 of R, G and B based on R, G and B components of input picture signals, respectively. With this, laser lights of P, G and B which have been optically modulated at horizontal line cycle based on the picture signals are generated in a time-division manner.

Then, R, G and B laser lights generated from the R, G and B laser light generating elements 25 to 27 are combined by a mirror 28 and dichroic mirrors 29 and 30 into one laser light. A laser light scanning element 32 is irradiated with this one laser light through a mirror 31.

The laser light scanning element 32 reflects the incident laser light and emits the same onto a screen 33 through the laser light projecting module 13. The light reflection angle can be controlled by the scanning element control module 24. In this case, the scanning element control module 24 controls the reflection angle of the laser light scanning element 32 so that laser light is scanned on the screen 33 in correspondence with a picture signal which has been output from the image processor 19, whereby a picture is displayed on the screen 33.

The picture displaying operation of the laser projector 11 is collectively controlled by a control module 34. The control module 34 is provided with a CPU (central processing unit) 34a therein, and controls various modules based on operation information obtained from the operating module 15 such that the operation content is reflected.

In this case, the control module 34 utilizes a memory 34b. The memory 34b mainly includes a ROM (read only memory) in which a control program executed by the CPU 34a is stored, a RAM (random access memory) for supplying a work area to the CPU 34a, and a nonvolatile memory in which various setting information sets and controls information sets are stored.

Further, the control module 34 controls the display module 14 to display the current state of the laser projector 11 and to display a menu for setting the laser projector 11 to various modes.

Here, the control module 34 includes a warning sound/voice generating module 34c. When it is required to emit laser light to outside from the laser light projecting module 13, the warning sound/voice generating module 34c generates a sound signal for giving a message to that effect by means of a sound/voice before emitting the laser light. The sound signal which has been output from the warning sound/voice generating module 34c is supplied to a speaker 35 and a sound/voice is output.

In this case, the sound/voice message contents are “Light will be emitted from this time on. Please do not directly see the light source” and the like. After the sound/voice message is generated, laser tight having preset prescribed output power is generated from the R, G and B laser light generating elements 25 to 27, and the light is emitted from the laser light protecting module 13 to outside.

When it is required to emit laser light to outside, before the laser light is emitted to outside, the sound/voice message to that effect is generated for users and then, laser light is actually emitted to outside. With this, safety can be enhanced sufficiently, and the laser light can suitably be used actually.

Here, when it is required to emit laser light to outside is when operation to require laser light to be emitted from the laser light projecting module 13 to outside is carried out by the operating module 15. More specifically, when it is required to emit laser light to outside is when the R, G and B laser light generating elements 25 to 27 are required to generate laser light, and is when the power switch of the operating module 15 is turned ON. In the case of a laser projector 11 having an operating key for emitting laser light from the laser light projecting module 13 to outside in addition to the power switch, when it is required to emit laser light to outside is when that operating key is operated.

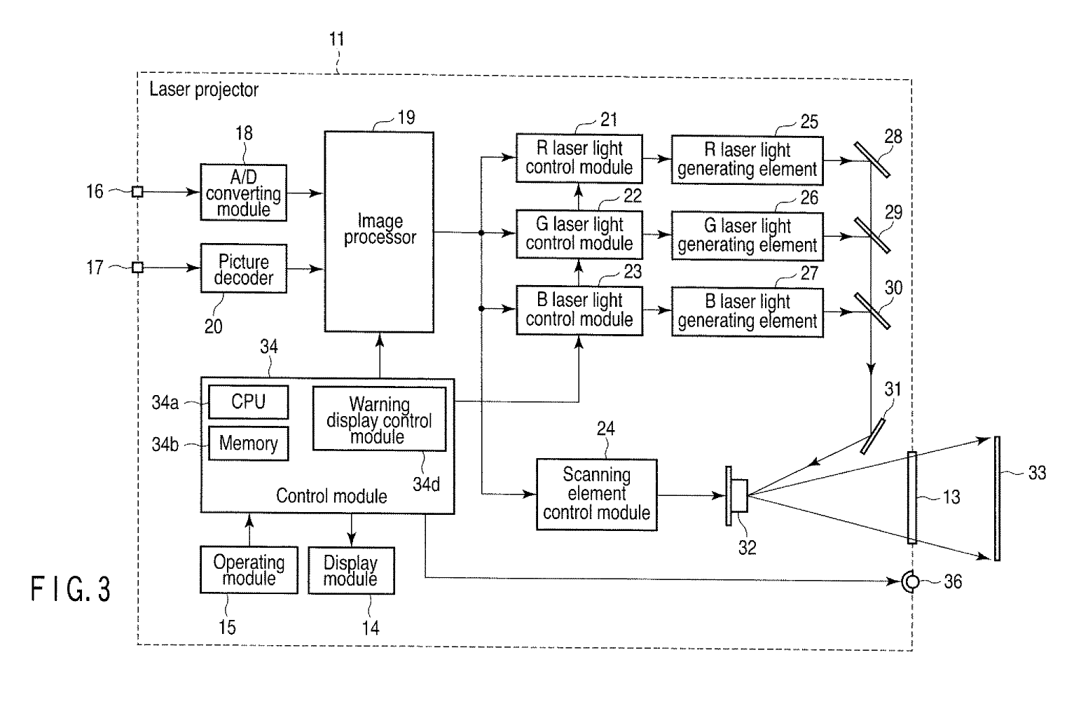

Next, FIG. 3 shows a signal processing system of the laser projector 11 of a second embodiment of the present invention. That is, in FIG. 3, the same elements as those shown in FIG. 2 are designated with the same symbols. The control module 34 includes a warning display control module 34d.

When it is required to emit laser light from the laser light projecting module 13 to outside, the warning d splay control module 34d allows the indicator lamp 36 disposed near the laser light projecting module 13 to light or blink for a preset time before emitting laser light to outside. After the indicator lamp 36 lights or blinks for the predetermined time, laser light having preset prescribed output power is generated from the R, G and B laser light generating elements 25 to 27, and the laser light is emitted from the laser light projecting module 13 to outside.

When it is required to emit laser light to outside, before the laser light is emitted to outside, the indicator lamp 36 lights or blinks for a predetermined time to give the alarm to users and then, laser light is actually emitted to outside. With this, safety can be enhanced sufficiently, and the laser light can suitably be used actually. After the laser light is emitted to outside, the indicator lamp 36 may stay ON or blinking or may be turned OFF.

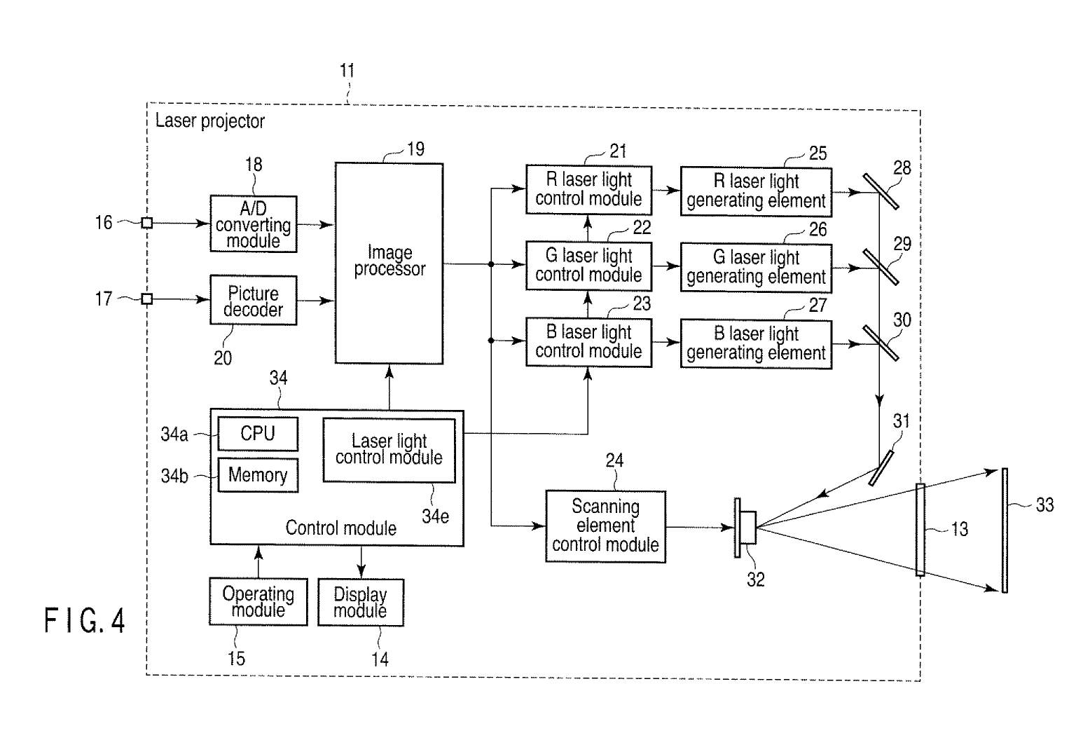

Next, FIG. 4 shows a signal processing system of a laser projector 11 according to a third embodiment of the invention. That is, in FIG. 4, the same elements as those shown in FIG. 2 are designated with the same symbols. The control module 34 includes a laser light control module 34e.

When it is required to emit laser light from the laser light projecting module 13 to outside, the laser light control module 34e controls the R, G and B laser light control modules 21 to 23 such that laser light generated from the R, G and B laser light generating elements 25 to 27 is dark in the beginning, i.e., the output power is low, and the laser light gradually become brighter, i.e., the output power becomes gradually higher.

When a preset predetermined time elapses after the laser light emission is required, laser light generated from the R, G and B laser light generating elements 25 to 27 reaches prescribed brightness, i.e., preset prescribed output power, and the laser light is emitted from the laser light projecting module 13 to outside. In the case of the third embodiment, in a period during which the emission of laser light is required and the laser light reaches prescribed output power, the projection display apparatus warns the users that laser light will be emitted from this time on.

When it is required to emit laser light to outside, the laser light generated from the R, G and B laser light generating elements 25 to 27 is controlled such that the output power thereof is low in the beginning, and becomes gradually higher, users are informed of that fact previously, safety can be enhanced sufficiently, and the laser light can suitably be used actually.

In the third embodiment, in the period during which it is required to emit laser light and the laser light reaches the prescribed output power, a warning message showing that laser light will be emitted from this time on may be displayed on the screen 33.

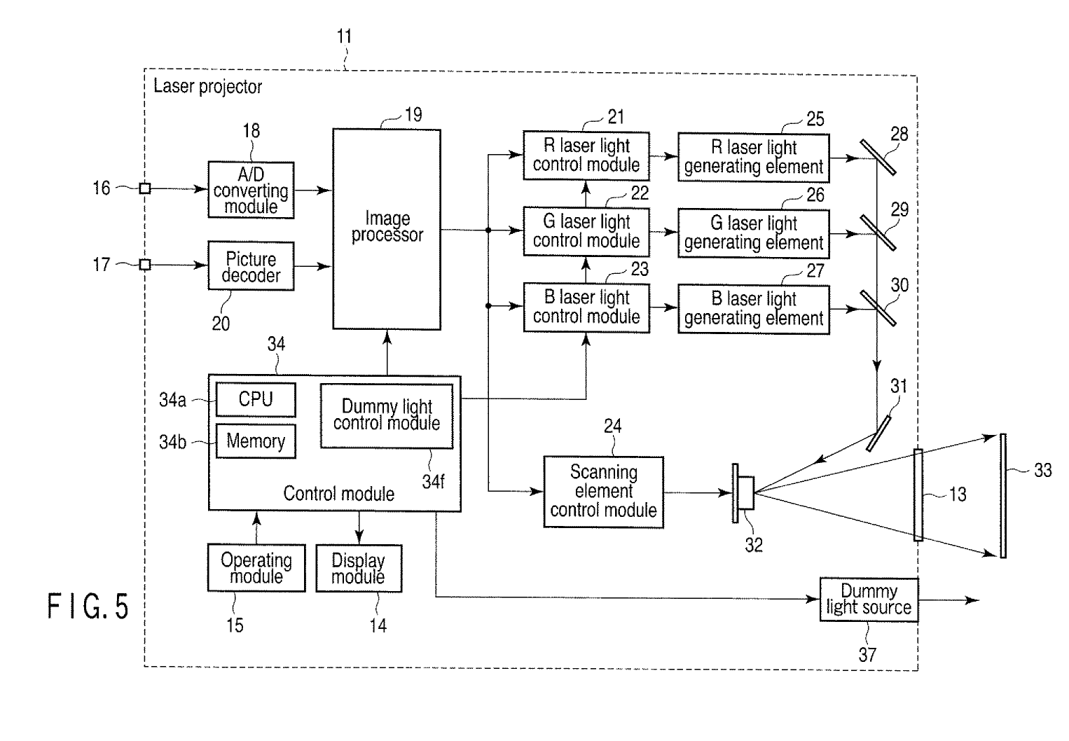

Next, FIG. 5 shows a signal processing system of a laser projector 11 according to a fourth embodiment of the invention. That is, in FIG. 5, the same elements as those shown in FIG. 2 are designated with the same symbols. The control module 34 includes a dummy light control module 34f.

When it is required to emit laser light from the laser light protecting module 13, the dummy light control module 34f allows a dummy light source 37 disposed near the laser light projecting module 13 to light for a preset predetermined time before laser light is emitted to outside. The dummy light source 37 is composed of an LED (light emitting diode) or the like and has a high directivity, the light thereof is safe even if a human body is irradiated with it, and the dummy light source 37 emits the light in the emitting direction of the laser light. After the dummy light source 37 lights for a predetermined time, laser light having a preset prescribed output power is generated from the R, G and B laser light generating elements 25 to 27, and the laser light is emitted from the laser light projecting module 13 to outside.

When it is required to emit laser light to outside, before laser light is emitted to outside, the dummy light source 37 disposed near the laser light projecting module 13 lights for a predetermined time in the emitting direction of the laser light to warn the users or that fact, and the laser light is actually emitted to outside. Thus, safety can be enhanced sufficiently, and the laser light can suitably be used actually. It is preferable that after the laser light is emitted to outside, the dummy light source 37 is turned OFF.

In the case of the fourth embodiment, the dummy light source 37 can display, on the screen 33, a warning message indicating that laser light will be emitted from this time on. In this case, the warning message may be “please do not directly see laser light during use” or the like.

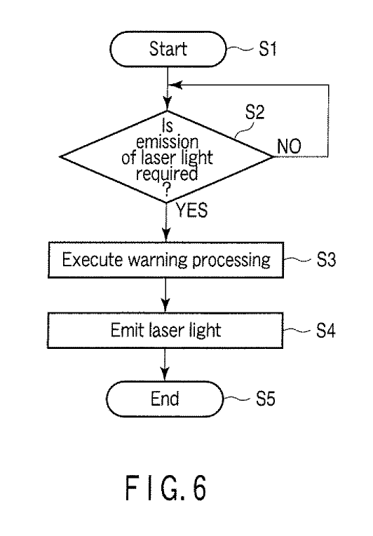

FIG. 6 is a flowchart collectively showing processing operations of warning carried out by the control module 34 before laser light is emitted. That is, if the processing is started (step S1), the control module 34 determines whether the emission of laser light is require in step S2.

If it is determined that emission of laser light is required (YES), the control module 34 executes any of the warning operations explained in the first to fourth embodiments in step S3 before emitting laser light. In this case, it is possible to carry out one of the warning operations, or the plurality of warning operations may selectively be combined and executed. Then, the control module 34 actually emits laser light in step S4, and completes the processing (step S5).

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A projection display apparatus comprising:
an input module configured to receive a picture signal;
a laser light generating element configured to generate laser light;
a modulating module configured to light-modulate the laser light generated from the laser light generating element based on the picture signal which has been input to the input module;
a scanning element configured to reflect the laser light which has been light-modulated by the modulating module, and control a light reflection angle of the laser light;
a scanning element control module configured to control the light reflection angle of the scanning element based on the picture signal which has been input to the input module, thereby scanning the laser light which has been light-modulated by the modulating module on the screen;
a warning module configured to warn that laser light will be emitted from this time on when the laser light generating element is required to generate the laser light; and
a control module configured to cause the laser light generating element to generate laser light having a preset prescribed output power in a state where the warning has been made by the warning module.

2. A projection display apparatus of claim 1, wherein
when operation for requiring the laser light generating element to generate laser light is carried out, the warning module warns that laser light will be emitted from this time on, by means of a sound/voice message.

3. A projection display apparatus or claim 1, wherein
when operation for requiring the laser light generating element to generate laser light is carried out, the warning module warns that laser light will be emitted from this time on, by lighting an indicator lamp.

4. A projection display apparatus of claim 3, wherein
the warning module makes the indicator lamp stay on even after the laser light is emitted from the laser light generating element.

5. A projection display apparatus of claim 1, wherein
when operation for requiring the laser light generating element to generate laser light is carried out, the warning module warns that laser light will be emitted from this time on, by blinking an indicator lamp.

6. A projection display apparatus of claim 5, wherein
the warning module makes the indicator lamp keep blinking even after the laser light is emitted from the laser light generating element.

7. A projection display apparatus of claim 1, wherein
when operation for requiring the laser light generating element to generate laser light is carried out, the warning module makes the laser light generating element generate laser light such that the laser light is dark in the beginning and then the laser light becomes gradually brighter, thereby warning that the laser light will be emitted from this time on.

8. A projection display apparatus of claim 1, wherein
when operation for requiring the laser light generating element to generate laser light is carried out, the warning module makes a dummy light source emit light having high directivity in an emitting direction of the laser light, thereby warning that the laser light will be emitted from this time on.

9. A projection display apparatus of claim 8, wherein
the warning module displays, on the screen, a message that laser light will be emitted from this time on, using light emitted from the dummy light source.

10. A control method of a projection display apparatus comprising: an input module configured to receive a picture signal; a laser light generating element configured to generate laser light; a modulating module configured to light-modulate the laser light generated from the laser light generating element based on the picture signal which has been input to the input module; a scanning element configured to reflect the laser light which has been light-modulated by the modulating module, and control a light reflection angle of the laser light; and a scanning element control module configured to control the light reflection angle of the scanning element based on the picture signal which has been input to the input module, thereby scanning the laser light which has been light-modulated by the modulating module on the screen, the method comprising:
warning that laser light will be emitted from this time on when the laser light generating element is required to generate laser light; and
causing the laser light generating element to generate laser light having a preset prescribed output power in a state where the warning has been made by the warning module.
